(19) United States
(12) Patent Application Publication
(10) Pub. No.: US 2015/0211273 A1
(43) Pub. Date: Jul. 30, 2015

(54) BRACKET AND ELECTRONIC DEVICE WITH THE SAME

(71) Applicant: ASUSTeK COMPUTER INC., Taipei (TW)

(72) Inventors: Tsung-Ju CHIANG, Taipei (TW); Chih-Ho HSIEH, Taipei (TW); Hsuan-Wu WEI, Taipei (TW); Shun-Lung WANG, Taipei (TW)

(21) Appl. No.: 14/603,994

(22) Filed: Jan. 23, 2015

(30) Foreign Application Priority Data
Jan. 24, 2014 (CN) 201410033644.0

(51) Int. Cl. E05D 7/12; G06F 1/16; E05D 11/08

(52) U.S. Cl. CPC E05D 7/12; E05D 11/08; G06F 1/1633; E05Y 2900/606

(57) ABSTRACT

A bracket for an electronic device is provided. The bracket includes a shaft, a second limiting component, and a first elastic component. A first limiting component is disposed at one end of the shaft. The second limiting component is disposed corresponding to the first limiting component. The first elastic component is connected with the second limiting component to make the first limiting component and the second limiting component form a holding state. When the shaft is rotated to reach a predetermined angle range, the first limiting component pushes against the second limiting component and forms a releasing state to detach a body from a base of the electronic device.

### CROSS-REFERENCE TO RELATED APPLICATION

This application claims the priority benefit of China application serial No. 201410033644.0, filed on Jan. 24, 2014. The entirety of the above-mentioned patent application is hereby incorporated by reference herein and made a part of specification.

### BACKGROUND OF THE INVENTION

1. Field of the Invention

The invention relates to a bracket and, more particularly, to a bracket applying to an electronic device.

2. Description of the Related Art

With the development of technology, display panels has been widely used in various kinds of electronic devices, such as computer products, mobile televisions, mobile phones, camcorders, notebook computers, desktop displays, and projection televisions. Among those products, convertible laptops with detachable keyboards are popular day by day.

A convertible laptop usually includes a display panel and a base, such as a keyboard, and the display panel can be used individually as a tablet computer or be used as a notebook computer by attached to the base.

Conventionally, a security mechanism is applied to hold the display panel with the base firmly, however, to release display panel from the base, users has to switch a button or a shaft which is inconveniently arranged.

Furthermore, transmission components such as switches are required for the convertible laptop additionally for users to manually switching the holding state to a release state, which makes the releasing mechanism complicated, and the switch components for assembly are increase, which results in more cost and more heavy device. Moreover, the transmission components are easily worn out and impact the appearance of the electronic device.

### BRIEF SUMMARY OF THE INVENTION

A bracket for an electronic device is provided. The bracket includes a shaft, a second limiting component, and a first elastic component. A first limiting component is disposed at one end of the shaft. The second limiting component is disposed corresponding to the first limiting component. The first elastic component is connected with the second limiting component to make the first limiting component and the second limiting component form a holding state. When the shaft is rotated within a predetermined angle range, the first limiting component pushes against the second limiting component and forms a releasing state.

An electronic device with a bracket is also provided. The electronic device includes a body and a base. The body is detachably and rotatably connected with the base.

The base includes a shaft, a second limiting component, and a first elastic component. A first limiting component is disposed at one end of the shaft. The second limiting component is disposed corresponding to the first limiting component. The first elastic component is the second limiting component connected with the second limiting component to make the first limiting component and the second limiting component form a holding state. When the shaft is rotated to within a predetermined angle range, the first limiting component pushes against the second limiting component and forms a releasing state.

The bracket and the electronic device with the bracket are capable to rotate the body to a specific angle range to drive the first limiting component to push against the second limiting component to form a releasing state, and thus the body and the base is capable of being detached.

These and other features, aspects and advantages of the present invention will become better understood with regard to the following description, appended claims, and accompanying drawings.

### BRIEF DESCRIPTION OF THE DRAWINGS

FIG. 1A is a stereoscopic schematic diagram showing a holding state according to a first embodiment;

FIG. 1B is a stereoscopic schematic diagram showing a releasing state according to the first embodiment;

FIG. 2A is a stereoscopic schematic diagram showing a holding state according to a second embodiment;

FIG. 2B is a stereoscopic schematic diagram showing a releasing according to a second embodiment;

FIG. 2C is a partial enlarged schematic diagram of a second limiting component in FIG. 2B;

FIG. 3 is a partial enlarged schematic diagram showing the holding state according to the first embodiment;

FIG. 4 is a side view schematic diagram showing a side of an electronic device according to an embodiment; and

FIG. 5 is another side view schematic diagram showing an electronic device according to an embodiment.

### DETAILED DESCRIPTION OF THE EMBODIMENTS

A bracket and an electronic device with the bracket are illustrated hereinafter accompanying drawings. For easily understanding, the same symbols denote the same components, and some indirect components are not shown for a clear figure.

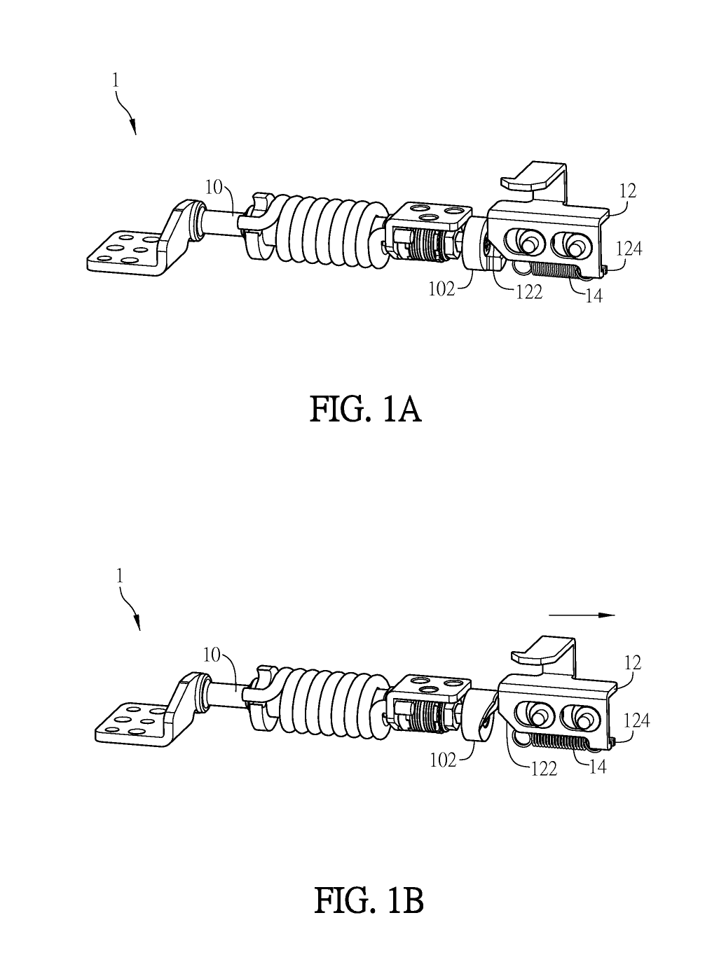

FIG. 1A and FIG. 1B are stereoscopic schematic diagrams showing a holding state and a releasing state in a first embodiment. A bracket 1 includes a shaft 10, a second limiting component 12, and a first elastic component 14.

A first limiting component 102 is disposed at one end of the shaft 10. The second limiting component 12 is disposed corresponding to the first limiting component 102. The first elastic component 14 is connected with the second limiting component 12 to make the first limiting component 102 and the second limiting component 12 form a holding state.

In an embodiment, the first limiting component 102 includes a cam, and the second limiting component 12 includes a butting portion 122. Furthermore, the second limiting component 12 may further include a hook 124. The first elastic component 14 is disposed on the second limiting component 12 to provide the hook 124 a restoring force, and another end of the first elastic component 14 is disposed on a component of an electronic device which is adapted with the bracket in the embodiment. In an embodiment, the first elastic component 14 is a spring or an elastic sheet, which is not limited herein.

The cam of the first limiting component 102 can push against or contact with the butting portion 122 of the second limiting component 12 to form the releasing state or the holding state.

Please refer to FIG. 1B. When the shaft 10 is rotated within a predetermined angle range, the first limiting component 102 pushes against the second limiting component 12 to form the releasing state. In detail, at the time, the cam of the first limiting component 102 pushes against the butting portion 122 of the second limiting component 12 and resists the restoring force of the first elastic component 14 (the direction of the restoring force is towards the first limiting component 102), the second limiting component 12 moves right, and the holding state is released.

In addition, the expression that “the first limiting component 102 pushes against or contacts with the second limiting component 12” is not limited to the direct push or contact, it is also an indirectly push or contact. For example, the first limiting component 102 may push against or contact with the second limiting component 12 via a transmission component, which is also in the scope of the invention.

The first elastic component 14 in the embodiment is for maintaining the holding state of the first limiting component 102 and the second limiting component 12. The first elastic component 14 also may provide a restoring force when the first limiting component 102 pushes against the second limiting component 12 during the rotating of the shaft 10, which is used as a fool-proof mechanism to avoid an accident releasing of the state limiting.

The “predetermined angle range” herein is adjustable according to different operating modes. For example, the angle in FIG. 1A is 0 degree, and when the shaft 10 is rotated to the predetermined angle range (120 to 135 degree in FIG. 1B), the first limiting component 102 pushes against the second limiting component 12 to form the releasing state. However, the predetermined angle range is not limited herein, and it can be adjusted to 45 degree, 90 degree, or 130 degree according to practical requirements.

In an embodiment, the first limiting component 102 and the second limiting component 12 is a wedge structure which can be hooked or a magnetic component in other embodiments. In an embodiment, the first limiting component and the second limiting component are magnetic components, the first limiting component and the second limiting component form the holding state via the first elastic component when the predetermined angle range is not reached. When the predetermined angle range is reached, the magnetic component of the first limiting component faces to and repels the magnetic component of the second limiting component (the first limiting component has the same polarity with the second limiting component) to against the elastic restoring force provided by the first elastic component, and then the releasing state is formed, therefore, a similar effect as this embodiment in FIG. 1A and FIG. 1B is achieved.

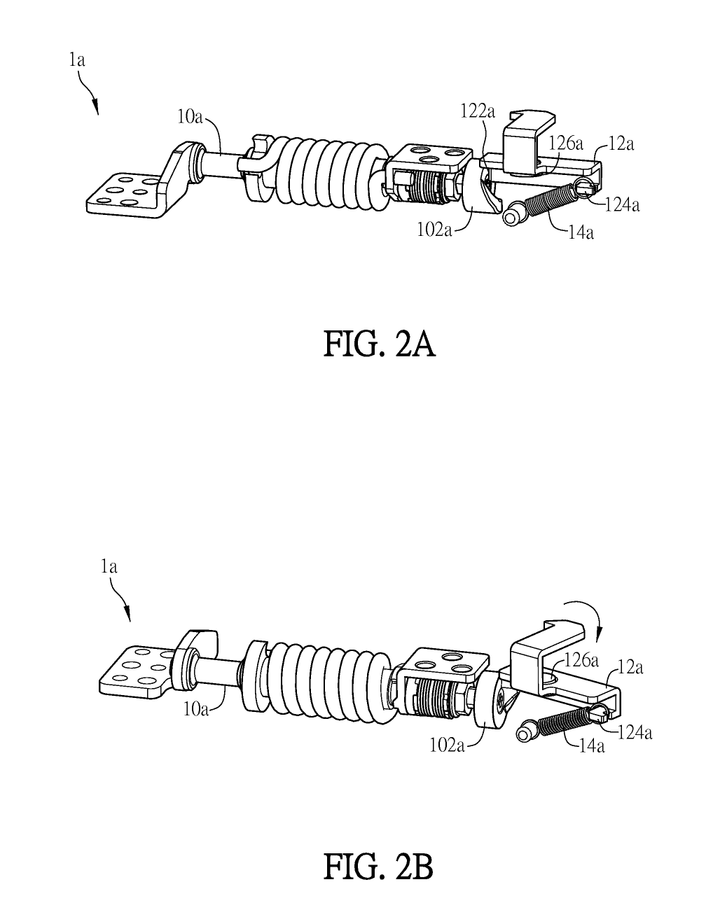

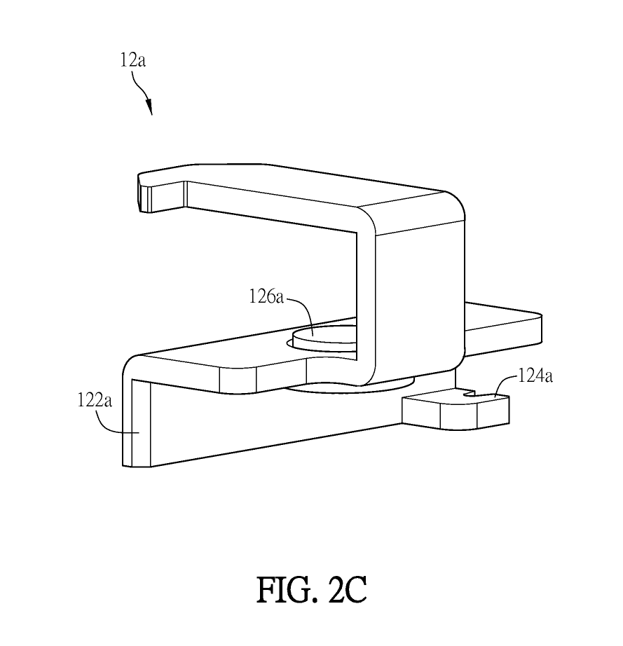

Please refer to FIG. 2A, FIG. 2B, and FIG. 2C. FIG. 2A and FIG. 2B are stereoscopic schematic diagrams showing a holding state and a releasing state according to a second embodiment. FIG. 2C is a partial enlarged schematic diagram of the second limiting component in the FIG. 2B.

Similarly, the first limiting component 102a in the embodiment may include a cam, and the second limiting component 12a may include a butting portion 122a. Moreover, the butting portion 122a in the embodiment may include a slope. The second position component 12a in the embodiment may further include a hook 124a.

The differences between the first and second embodiment includes the follows. First, the direction of the slope of the butting portion 122a of the second limiting component 12a is different from the direction of the slope of the butting portion 122 in the first embodiment. Second, the first elastic component 14a is disposed at the hook 124a of the second limiting component 12a and provides a restoring force to make the first limiting component 102 and the second limiting component 12 restore to the holding state.

Please refer to FIG. 2B, when the shaft 10a is rotated to a predetermined angle range, the first limiting component 102a may push against the butting portion 122a of the second limiting component 12a to make the second limiting component 12a tilt or rotate (the second limiting component 12a in the embodiment is only fixed by a fixing component 126a, therefore, the second limiting component 12a is able to tilt or rotate along a axis). At the moment, the first elastic component 14a is stretched, and the releasing state is formed. Other components and mechanisms therebetween are the same as those in the first embodiment, which is not described again for concise purpose.

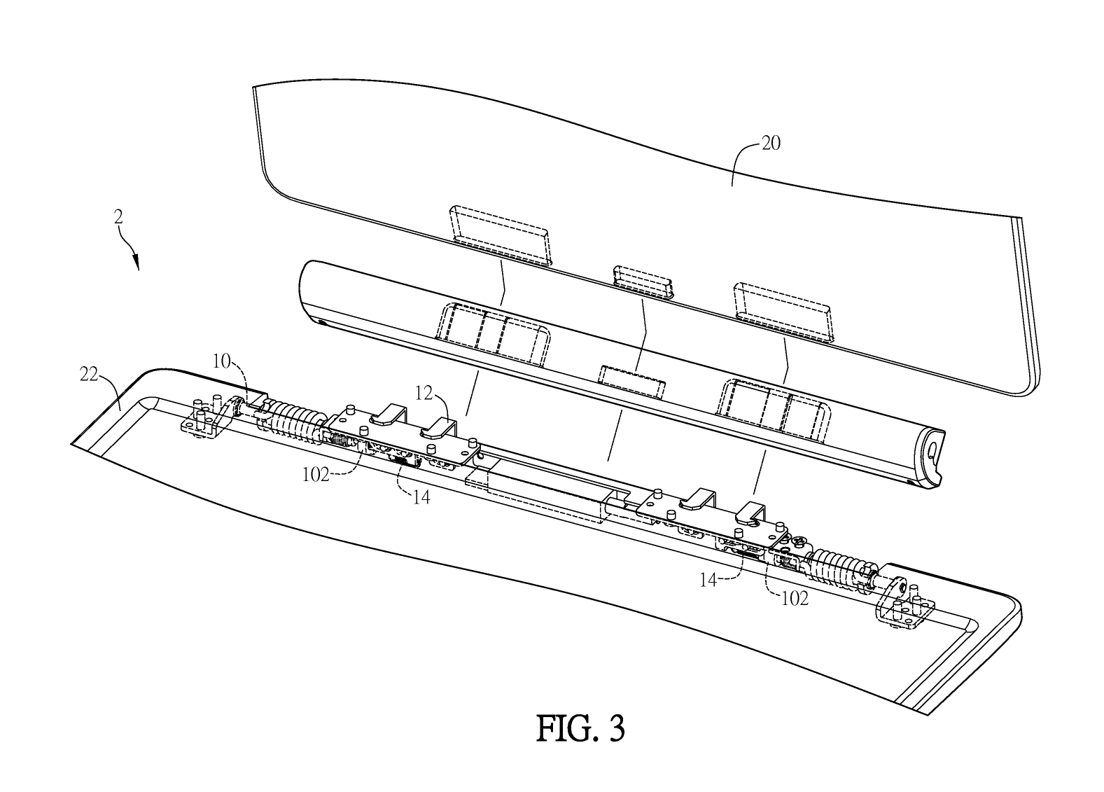

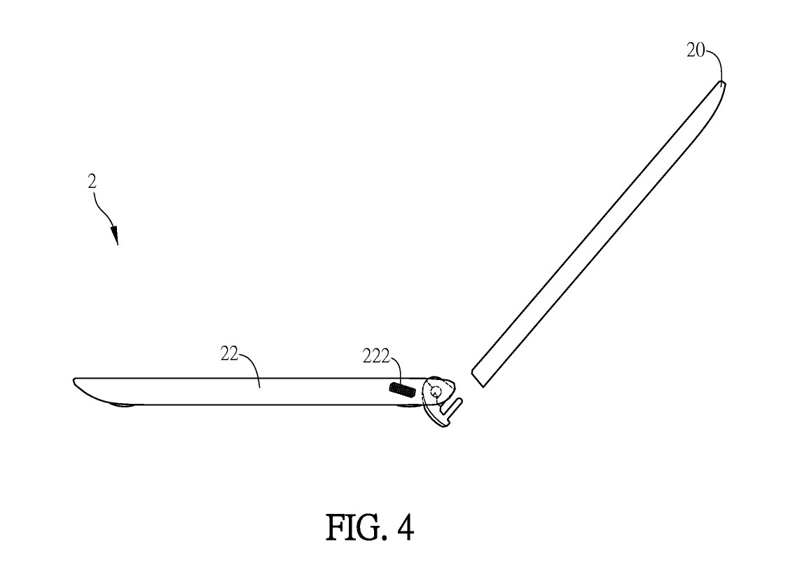

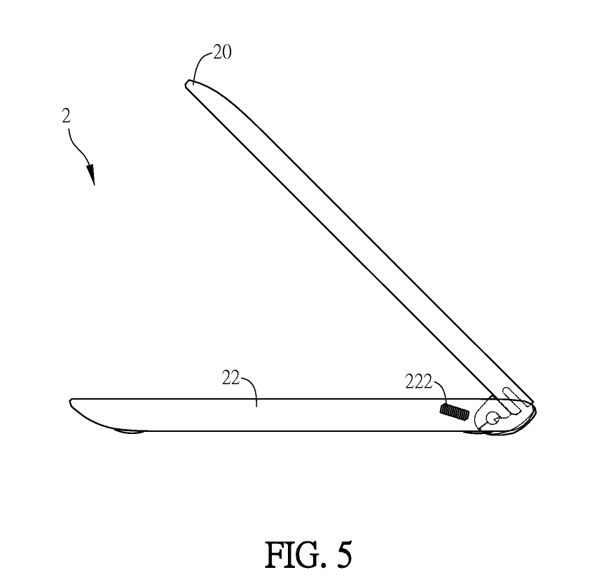

Please continue to refer to FIG. 3 to FIG. 5. FIG. 3 is a partial enlarged schematic diagram showing the holding state according to the first embodiment. FIG. 4 is a side view schematic diagram showing a side of an electronic device according to an embodiment. FIG. 5 is another side view schematic diagram showing an electronic device according to an embodiment.

An electronic device 2 with a bracket is shown. The electronic device 2 includes a body 20 and a base 22. The body 20 is detachably and pivotally connected with the base 22.

The base 22 includes a shaft 10, a second limiting component 12, and a first elastic component 14. In an embodiment, the first elastic component 14 is a spring or an elastic sheet. A first limiting component 102 is disposed at one end of the shaft 10, and the first limiting component 102 is corresponding to the second limiting component 12.

The first elastic component 14 is connected with the second limiting component 12 to make the first limiting component 102 and the second limiting component 12 form a holding state, so as to stably fix the body 20 on the base 22. The body 20 in the embodiment further includes a plurality of protruding components to match with slots of the base 22 to fix the base 22 on the body 20. In detail, in the holding state, a butting portion (not shown in the figures) of the second limiting component 12 can fix the body on the base 22 in the embodiment.

The base 22 may further include a second elastic component 222 (as shown in FIG. 5), and the second elastic component 222 is a spring or an elastic sheet. The second elastic component 222 is for connecting the shaft 10 and providing a restoring force to make the first limiting component 102 and the second limiting component 12 restore at the holding state. In detail, the second elastic component 222 is used to provide the elastic restoring force to the shaft 10. When the shaft 10 rotates within the predetermined angle range, the elastic restoring force of the second elastic component 222 can make the bracket form the holding state again. As a result, it can avoid that the body 20 connected with the shaft 10 is accidently detached from the base 22 due to the reason that the second limiting component 12 is in the releasing state in the predetermined angle range.

When the body 20 drives the shaft 10 to rotate to the predetermined angle range (the body 20 is rotated relatively to the base 22), the first limiting component 102 pushes against the second limiting component 12 and releases the holding state. In other words, the cam of the first limiting component 102 pushes against the butting portion of the second limiting component 12 at the time, presses the butting portion of the second limiting component 12, and resists a pull force of the first elastic component 14, then, the second limiting component 12 is pushed to move right and the releasing state is formed, which makes the body 20 detached from the base 22.

Moreover, some mechanisms are provided in the embodiment to inform users that the body 20 is rotated and reached to the predetermined angle range (in other words, users are informed whether the body 20 is at the releasing state or at the holding state).

In an embodiment, a state prompting mechanism is applied to the bracket or the base of the electronic device to notice users that the predetermined angle range is reached. The state prompting mechanism can be performed via an image, sound, alert lights, or sense of handle, which is not limited herein.

In an embodiment, the state prompting mechanism is performed by an image notice that displays on the electronic device, or alert lights that execute by a light emitting unit or a color block disposed on the first limiting component. For more detail in the embodiment of light emitting unit, when the body 20 not yet reaches the predetermined angle range, the light emitting unit emits in red color (which means in the holding state). When the body 20 is rotated to reach the predetermined angle range, the light emitting unit emits in green color to inform users that the releasing state is achieved.

In an embodiment, as shown in FIG. 4, the state prompting mechanism is a color block disposed on the first limiting component 102, the first limiting component 102 is partially exposed from the body 20. When the body 20 drives the first limiting component 102 to rotate to the predetermined angle range, the color block (ex, green) of the first limiting component 102 is exposed, therefore, users can easily know that the angle is at the releasing state.

In an embodiment, the state prompting mechanism is a click sound effect. At the moment that the body 20 is rotated to reach the predetermined angle range, a click sound following with detached of the body from the base of the electronic device is generated to inform users that the body of the electronic device is about to separate.

In an embodiment, the state prompting mechanism is also achieved via a changing sense of a handle feeling, such as falling feeling. For example, the body 20 resists a twist force to rotate before the body 20 reaches the predetermined angle range, and the body 20 resists an elastic restoring force of the second elastic component 222 when the body 20 rotates and reaches the predetermined angle range. Therefore, when users rotate the body 20 along the axis and keep applying the same force (the twist force herein is larger than the elastic restoring force), the user would feel falling feeling, and then the user can realize that the body 20 is rotated to the predetermined angle range.

The state prompting mechanism is not limited to the above embodiments, and one or more state prompting mechanisms are allow to use alone or in combination according to different requirements.

In sum, the body of the electronic device is rotated to the specific angle range to drive the first limiting component of the bracket to push against the second limiting component to form the releasing state, and then the body and the base of the electronic device can be detached.

Via the configuration, a physical switch is no longer required on the base to release the body of the electronic device, and thus the electronic device is simplified, the cost and the weight of the electronic device are decreased, furthermore, the artistic of the electronic device appearance would be affected.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An bracket for an electronic device, comprising:
a shaft, wherein a first limiting component is disposed at one end of the shaft;
a second limiting component disposed corresponding to the first limiting component; and
a first elastic component connected with the second limiting component to make the first limiting component and the second limiting component form a holding state;
wherein when the shaft is rotated and reached a predetermined angle range, the first limiting component pushes against the second limiting component and forms a releasing state.

2. The bracket according to claim 1, wherein the first limiting component includes a cam, and the second limiting component includes a butting portion.

3. The bracket according to claim 1, further comprising a second elastic component connected to the shaft.

4. The bracket according to claim 3, wherein the first elastic component or the second elastic component is a spring or an elastic sheet.

5. An electronic device with a bracket, comprising:
a body; and
a base detachably and pivotally connected with the body, wherein the base includes a bracket, and the bracket includes a shaft, a second limiting component, and a first elastic component, wherein a first limiting component is disposed at one end of the shaft, the first limiting component is disposed corresponding to the second limiting component, the first elastic component is connected with the second limiting component to make the first limiting component and the second limiting component form a holding state,
wherein when the body drives the shaft to rotate and reach a predetermined angle range, the first limiting component pushes against the second limiting component and forms a releasing state.

6. The electronic device according to claim 5, wherein the first limiting component includes a cam, and the second limiting component includes a butting portion.

7. The electronic device according to claim 5, wherein the base further includes a second elastic component is connected with the shaft and making the first limiting component and the second limiting component form the holding state.

8. The electronic device according to claim 7, wherein the first elastic component or the second elastic component is a spring or an elastic sheet.

9. The electronic device according to claim 5, wherein a state prompting mechanism is applied to notice that the predetermined angle range is reached.
